(19) United States
(12) Patent Application Publication
(10) Pub. No.: US 2009/0292857 A1
(43) Pub. Date: Nov. 26, 2009

(54) CACHE MEMORY UNIT

(75) Inventor: Jun TANABE, Yokohama-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Kabushiki Kaisha Toshiba, Tokyo (JP)

(21) Appl. No.: 12/390,599

(22) Filed: Feb. 23, 2009

(30) Foreign Application Priority Data
May 26, 2008 (JP) 2008-137005

(51) Int. Cl. G06F 12/08; G06F 12/00

(52) U.S. Cl. 711/3; 711/118; 711/E12.001

(57) ABSTRACT

A cache memory unit temporarily stores data having been stored in a main memory, the valid bits of the flag memory corresponding to the lines of the entries at the to-be-invalidated entry addresses are rewritten so as to indicate invalidation of the lines of the entries at the to-be-invalidated entry addresses, so that the lines of the entries at the to-be-invalidated entry addresses are invalidated.

### CROSS-REFERENCE TO RELATED APPLICATION

This application is based upon and claims the benefit of priority from the prior Japanese Patent Application No. 2008-137005, filed on May 26, 2008, the entire contents of which are incorporated herein by reference.

### BACKGROUND OF THE INVENTION

1. Field of the Invention

The present invention relates to a cache memory unit for storing data.

2. Background Art

Conventionally, when invalidating (resetting) a cache in a continuous main memory area of a large capacity, the following methods are generally practiced.

### (Method A)

Tags are sequentially accessed to confirm the presence or absence of data of an area to be invalidated, so that the tags are checked for a hit/miss. When a hit is found, the entry of data is invalidated. In method A, when an area to be invalidated has “P” lines and an invalidation check requires “M” cycles, a time period of P×M cycles is necessary.

### (Method B)

The tags of all cache entries are checked. When data of an area to be invalidated is stored in a cache, the entry of data is invalidated. In method B, when a check of an entry requires “N” cycles, a time period determined by the number of entries×N cycles is necessary.

When the area to be invalidated is small, that is, in the case of P×M<the number of entries×N, method A is used.

When the area to be invalidated is large, method B is used.

In these invalidating methods of the prior art, when an area to be invalidated is large, the number of cycles considerably increases with the number of cache entries.

In order to solve this problem, a method of indiscriminately invalidating all cache entries is available. In this method, it is not necessary to check tags and thus perform invalidation at high speed. However, the invalidation is also performed on a part other than an area to be invalidated, resulting in extremely severe conditions of use.

In another cache memory unit of the prior art, a start address, a distance between elements, prime numbers for processing, and so on are set for an area to be invalidated. Thus the cache memory unit automatically reads tags in a sequential manner and invalidates the entry of an area to be invalidated (for example, see Japanese Patent Laid-Open No. 08-335189).

In the cache memory unit, high-speed processing can be expected when a processor and so on read a tag for each entry and perform invalidation. However, the cache memory unit requires a certain period of time for a large number of cache entries and a large area to be invalidated.

### SUMMARY OF THE INVENTION

According to one aspect of the present invention, there is provided: a cache memory unit that temporarily stores data having been stored in a main memory, comprising:

a cache memory circuit which has entries including a plurality of lines including a data memory for temporarily storing the data having been stored in the main memory, a tag memory for storing tag addresses which are addresses of the data in the main memory, and a flag memory for storing valid bits;

an address monitoring setting register which stores a to-be-invalidated address range including addresses of a to-be-invalidated area of the main memory, and stores entry addresses of the lines of the entries to be invalidated; and

an address judging circuit which compares the tag addresses and the to-be-invalidated address range stored in the address monitoring setting register, and stores, in the address monitoring setting register, to-be-invalidated entry addresses which are the entry addresses of the lines corresponding to the tag memory for storing the tag addresses included in the to-be-invalidated address range, when the tag addresses are included in the to-be-invalidated address range,

wherein the valid bits of the flag memory corresponding to the lines of the entries at the to-be-invalidated entry addresses are rewritten so as to indicate invalidation of the lines of the entries at the to-be-invalidated entry addresses, so that the lines of the entries at the to-be-invalidated entry addresses are invalidated.

According to the other aspect of the present invention, there is provided: a cache memory unit that temporarily stores data having been stored in a main memory, comprising:

a cache memory circuit which has entries including a plurality of lines including a data memory for temporarily storing the data having been stored in the main memory, a tag memory for storing tag addresses which are addresses of the data in the main memory, and flip-flops for storing valid bits;

an address monitoring setting register which stores a to-be-invalidated address range including addresses of a to-be-invalidated area of the main memory, and stores entry addresses of the lines of the entries to be invalidated; and

an address judging circuit which compares the tag addresses and the to-be-invalidated address range stored in the address monitoring setting register, and stores, in the address monitoring setting register, to-be-invalidated entry addresses which are the entry addresses of the lines corresponding to the tag memory for storing the tag addresses included in the to-be-invalidated address range, when the tag addresses are included in the to-be-invalidated address range,

wherein the valid bits of the flip-flops corresponding to the lines of the entries at the to-be-invalidated entry addresses are rewritten so as to indicate invalidation of the lines of the entries at the to-be-invalidated entry addresses, so that the lines of the entries at the to-be-invalidated entry addresses are invalidated,

the to-be-invalidated address range is specified by a start address and the size of the to-be-invalidated area of the main memory.

According to still further aspect of the present invention, there is provided: a cache memory unit that temporarily stores data having been stored in a main memory, comprising:

a cache memory circuit which has entries including a plurality of lines including a data memory for temporarily storing the data having been stored in the main memory, a tag memory for storing tag addresses which are addresses of the data in the main memory, and a flag memory for storing valid bits;

an address monitoring setting register which stores a to-be-invalidated address range including addresses of a to-be-invalidated area of the main memory, and stores entry addresses of the lines of the entries to be invalidated; and

an address judging circuit which compares the tag addresses and the to-be-invalidated address range stored in the address monitoring setting register, and stores, in the address monitoring setting register, to-be-invalidated entry addresses which are the entry addresses of the lines corresponding to the tag memory for storing the tag addresses included in the to-be-invalidated address range, when the tag addresses are included in the to-be-invalidated address range.

### BRIEF DESCRIPTION OF THE DRAWINGS

FIG. 1 is block diagram showing a system configuration including a cache memory unit 100 according to a first embodiment which is an aspect of the present invention;

FIG. 2 is a diagram showing an example of the main configuration of a cache memory circuit 1 in the cache memory unit 100 shown in FIG. 1;

FIG. 3 is a diagram showing an example of the main configuration of an address monitoring setting register 2 in the cache memory unit 100 shown in FIG. 1; and

FIG. 4 is a diagram showing a system configuration including a cache memory unit 100a according to the second embodiment which is an aspect of the present invention.

### DETAILED DESCRIPTION

A cache memory unit of the present invention invalidates, during invalidation of entries, only the data of corresponding lines at high speed without using a special tag memory such as a content addressable memory (CAM).

Embodiments of the present invention will be described below in accordance with the accompanying drawings.

### First Embodiment

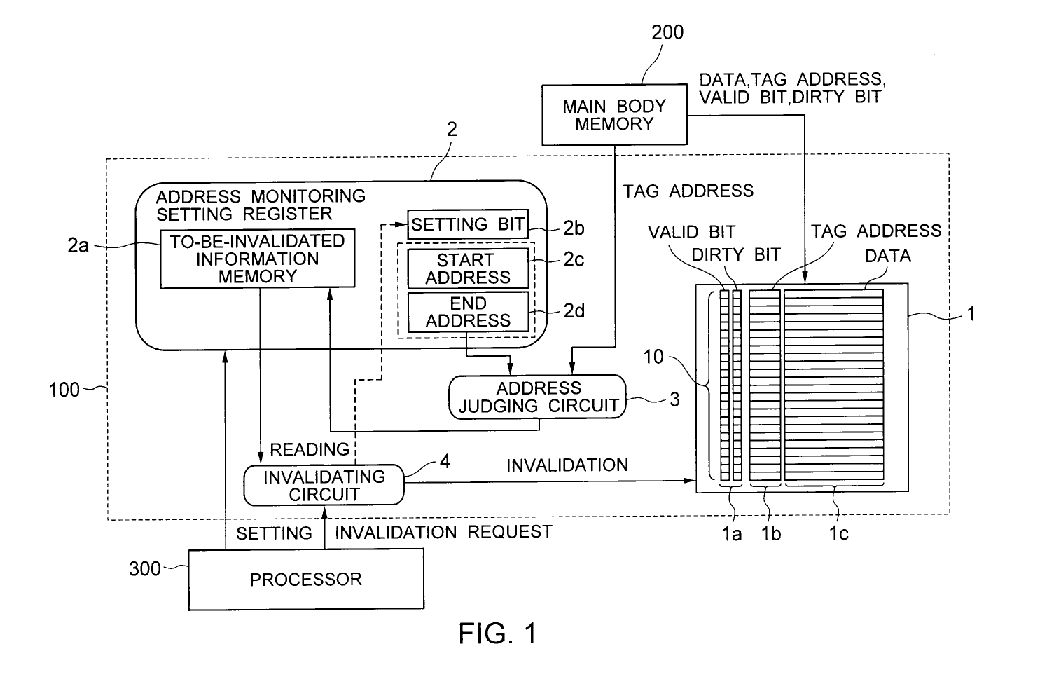

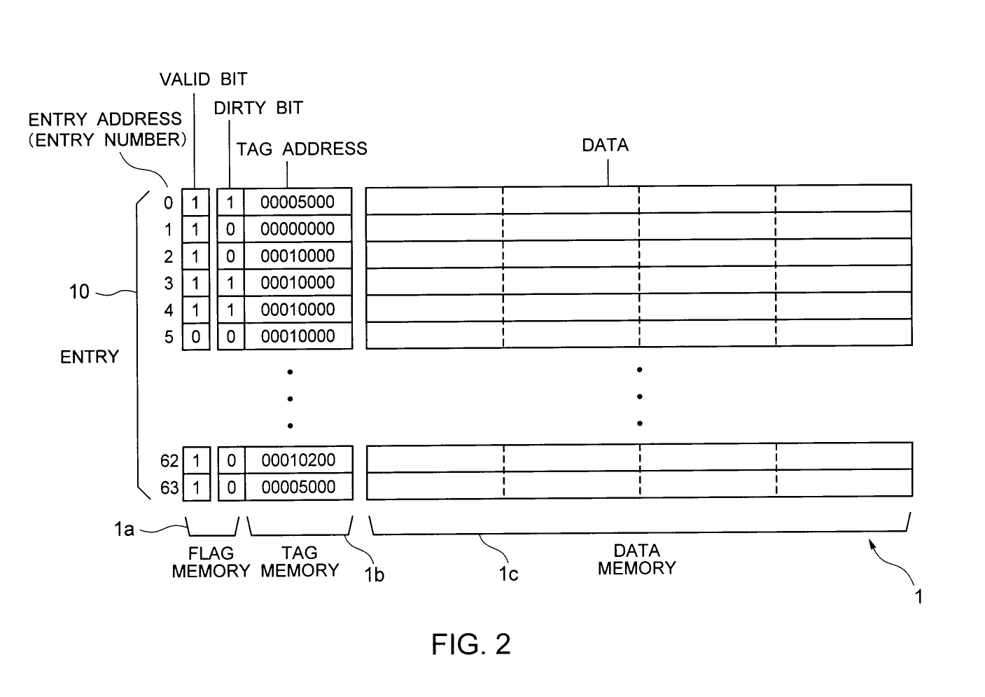

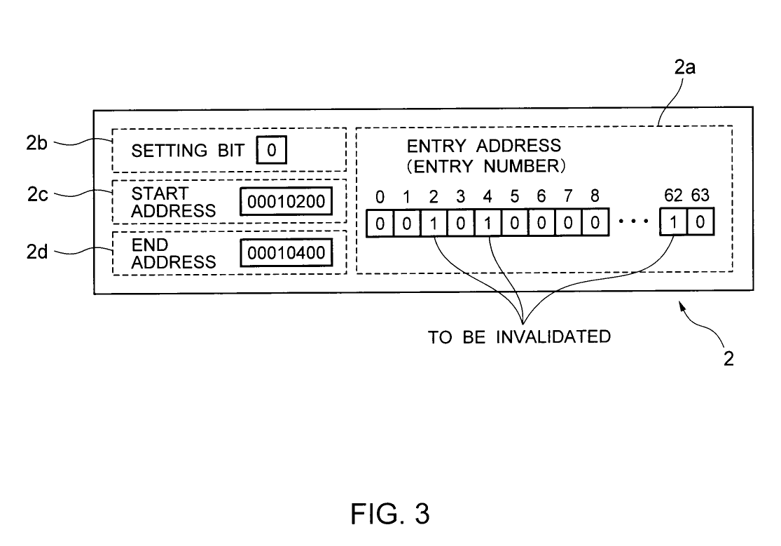

FIG. 1 shows a system configuration including a cache memory unit 100 according to a first embodiment which is an aspect of the present invention. FIG. 2 shows an example of the main configuration of a cache memory circuit 1 in the cache memory unit 100 shown in FIG. 1. FIG. 3 shows an example of the main configuration of an address monitoring setting register 2 in the cache memory unit 100 shown in FIG. 1.

As shown in FIG. 1, the cache memory unit 100 includes the cache memory circuit 1, the address monitoring setting register 2, an address judging circuit 3, and an invalidating circuit 4.

The cache memory unit 100 temporarily stores data having been stored in a main memory 200. Further, the cache memory unit 100 is controlled based on an instruction from a processor 300.

As shown in FIGS. 1 and 2, the cache memory circuit 1 has entries 10. The entries 10 include a plurality of lines which include a flag memory 1a, a tag memory 1b, and a data memory 1c.

As shown in FIG. 2, the lines of the entries 10 are identified by entry addresses (entry numbers).

The data memory 1c temporarily stores data having been stored in the main memory 200.

The tag memory 1b stores tag addresses which are the addresses of the data in the main memory 200.

The flag memory 1a stores valid bits and dirty bits. The flag memory 1a is made up of, for example, flip-flops. Based on the valid bits, for example, an external circuit (including the processor 300) and the like determine whether to read the date of the entries 10 corresponding to the flag memory 1a where the valid bits are stored.

For example, when the valid bits are “0”, the external circuit is set not to read the data of the corresponding lines but to read data from the main memory 200 (the lines are invalidated). At the same time, the read data from the main memory is stored in the cache memory unit 100.

When the valid bits are “1”, the external circuit is set to read the data of the corresponding lines (the lines are validated).

For example, for an instruction cache, the cache memory circuit 1 stores valid bits in the flag memory 1a. For a data cache, the cache memory circuit 1 stores valid bits and dirty bits in the flag memory 1a. As described above, in the present embodiment, the cache memory circuit 1 stores valid bits and dirty bits in the flag memory 1a.

As shown in FIG. 3, the address monitoring setting register 2 has a to-be-invalidated information memory 2a. The to-be-invalidated information memory 2a stores bits corresponding to the entry addresses of the lines of the entries 10 in the cache memory circuit 1.

For example, bits corresponding to entry addresses 2, 4, . . . , 62 are “1” and bits corresponding to the other entry addresses are “0”. The bits “1” indicate that data to be invalidated is stored in the data memory 1c, on the lines of the corresponding entry addresses. The bits “0” indicate that data not to be invalidated is stored in the data memory 1c, on the lines of the corresponding entry addresses. That is to say, these bits indicate that the lines of the entries 10 corresponding to the entry addresses 2, 4, . . . , 62 are to be invalidated and the other lines are not to be invalidated. In other words, these bits indicate whether or not data of a to-be-invalidated area of the main memory 200 is stored, on the corresponding lines of the entries 10, in the data memory 1c.

That is to say, by storing information of these bits, the address monitoring setting register 2 stores to-be-invalidated entry addresses which are the entry addresses of the lines of the entries 10 to be invalidated.

The address monitoring setting register 2 stores a setting bit 2b. For example, the address monitoring setting register 2 receives a control signal from, for example, the processor 300 and the setting bit 2b is rewritten from “0” to “1”, so that the address monitoring setting register 2 changes from a stopped state to an operated state.

Further, the address monitoring setting register 2 stores a to-be-invalidated address range which includes the addresses of a to-be-invalidated area including data to be invalidated in the main memory 200. The address monitoring setting register 2 stores, for example, a start address 2c and an end address 2d of the to-be-invalidated area of the main memory 200, as the to-be-invalidated address range. In other words, the addresses to be invalidated are identified by the start address 2c and the end address 2d.

The to-be-invalidated address range may be, for example, the start address, the size, and so on of the to-be-invalidated area of the main memory 200 as long as the address area is uniquely identified.

More than one address monitoring setting register 2 may be provided in the cache memory unit 100.

The address judging circuit 3 compares the tag addresses and the to-be-invalidated address range stored in the address monitoring setting register. When the tag addresses are included in the to-be-invalidated address range, the address judging circuit 3 stores, in the address monitoring setting register 2, the to-be-invalidated entry addresses which are the entry addresses of the lines of the entries 10 corresponding to the tag memory 1b where the tag addresses are stored. In other words, the address judging circuit 3 outputs information according to the comparison result and stores the information in the address monitoring setting register 2.

That is to say, the address judging circuit 3 determines whether or not an area specified by the address monitoring setting register 2 includes the address of data newly stored in the cache memory circuit 1 at the replacement of cache data. Further, the address judging circuit 3 updates the to-be-invalidated information memory 2a of the address monitoring setting register 2 according to the judgment result.

The invalidating circuit 4 is fed with, from the external processor 300, a command to invalidate an entry. When fed with the command, the invalidating circuit 4 reads the to-be-invalidated entry addresses stored in the address monitoring setting register 2. Further, the valid bits of the flag memory 1a corresponding to the lines of the entries 10 at the read to-be-invalidated entry addresses are rewritten by the invalidating circuit 4 so as to indicate invalidation of the lines of the entries 10 at the to-be-invalidated entry addresses. In this case, the valid bits are rewritten, for example, from “1” to “0”.

Thus by setting the valid bits at “0”, the corresponding lines of the entries 10 are invalidated. In other words, by setting the valid bits at “0”, data stored in the data memory 1c corresponding to the lines of the entries 10 corresponding to the valid bits is set not to be read by an external circuit (including the processor 300) and the like.

In this way, the invalidating circuit 4 invalidates the corresponding lines of the entries 10 in the cache memory circuit 1 based on the information stored in the to-be-invalidated information memory 2a as necessary.

The following will describe an example of an operation for invalidating the corresponding lines of the entries 10 in the cache memory unit 100 configured thus.

First, the processor 300 determines whether or not a used memory area of the main memory 200 is an area to be invalidated later.

Further, before the processor 300 accesses an area to be invalidated, the processor 300 sets the start address 2c and the end address 2d of the address monitoring setting register 2. Generally, whether a used memory area is to be invalidated or not is determined by a program model and is often recognized before access is made to the cache memory circuit 1.

Moreover, the processor 300 sets the setting bit 2b at, for example, “1” (valid) and starts the checking operation of the address monitoring setting register 2.

By setting the setting bit 2b at “1”, bits are all reset to “0” in the to-be-invalidated information memory 2a which has indicated that the cache memory circuit 1 includes the data of an area to be invalidated in the main memory 200.

After the setting bit 2b is set at “1”, when data is replaced with another data for an entry of the cache memory circuit 1, the address judging circuit 3 compares the tag address and the to-be-invalidated address range stored in the address monitoring setting register.

Thus the address judging circuit 3 checks whether or not the address (tag address) of data newly stored in the cache memory circuit 1 from the main memory 200 is included in the to-be-invalidated address range stored in the address monitoring setting register 2.

When the tag address is included in the to-be-invalidated address range, the address judging circuit 3 stores, in the address monitoring setting register 2, a to-be-invalidated entry address which is the entry address of the line of the entry 10 corresponding to the tag memory 1a where the tag address is stored. In other words, the address judging circuit 3 outputs information corresponding to a comparison result and stores the information in the address monitoring setting register 2.

That is to say, at the replacement of cache data, the address judging circuit 3 judges whether or not the address of data newly stored in the cache memory circuit 1 is included in the to-be-invalidated address range stored in the address monitoring setting register 2. According to the judgment result, the address judging circuit 3 updates the to-be-invalidated information memory 2a of the address monitoring setting register 2. For example, when the address of data newly stored in the cache memory circuit 1 is included in the to-be-invalidated address range, the bit of the corresponding entry in the to-be-invalidated information memory 2a is set at “1”.

The foregoing checking operation of the cache memory unit 100 is performed in parallel with the operation of accessing the main memory 200 and storing data having been read from the main memory 200 in the data memory 1c of the cache memory circuit 1. Therefore, the checking operation is hidden by the replacement time of the cash.

At the completion of the checking operation, a preparation for invalidating the corresponding lines of the entries in the cache memory circuit 1 is completed.

Next, when the processor 300 as accessed the lines of the entries 10 to be invalidated and then invalidates the lines of the entries, the processor 300 issues a command to the invalidating circuit 4.

When fed with the command, the invalidating circuit 4 reads all the bits stored in the to-be-invalidated information memory 2a. In other words, when fed with the command, the invalidating circuit 4 reads the to-be-invalidated entry addresses stored in the address monitoring setting register 2. Further, the valid bits of the flag memory 1a corresponding to the lines of the entries 10 at the read to-be-invalidated entry addresses are rewritten by the invalidating circuit 4 so as to indicate invalidation of the lines of the entries 10 at the to-be-invalidated entry addresses. In this case, the valid bits are rewritten, for example, from “1” to “0”.

Thus by setting the valid bits at “0”, the corresponding lines of the entries 10 are invalidated. In other words, by setting the valid bits at “0”, data stored in the data memory 1c corresponding to the lines of the entries 10 corresponding to the valid bits is set not to be read by an external circuit (including the processor 300) and the like.

In this way, the invalidating circuit 4 invalidates the corresponding lines of the entries 10 in the cache memory circuit 1 based on the information stored in the address monitoring setting register 2 as necessary.

At this point, the invalidating circuit 4 sets (invalidates) the setting bit 2b of the address monitoring setting register 2 at “0”. Thus the operation of the address monitoring setting register 2 is stopped.

In the present embodiment, as described above, the flag memory 1a is made up of flip-flops. Thus all the valid bits can be simultaneously written, so that invalidation is completed in one cycle.

Through the above operation, the cache memory unit 100 invalidates the corresponding lines of the entries 10.

According to the cache memory unit 100 of the present invention, the entries 10 to be invalidated in the cache memory circuit 1 has been recognized upon invalidation, so that only the corresponding entries of the cache memory circuit can be invalidated.

Thus unlike the prior art, it is possible to reduce a time for reading tags. In other words, invalidation can be performed faster than in the prior art.

Particularly, in the cache memory unit of the present invention, the valid bit memory of the cache memory circuit is made up of flip-flops. Thus for an area to be invalidated, invalidation can be performed in one cycle in the cache memory circuit.

The flag memory 1a may not be made up flip-flops. In this case, the valid bits cannot be written in one cycle. However, entries to be invalidated can be identified by reading the bits of the address monitoring setting register 2. Thus it is not necessary to sequentially read the tag memory 1b during invalidation. The invalidating circuit 4 sequentially sets (invalidates), at “0”, the valid bits for the lines of the entries 10 to be invalidated, so that the processing can be achieved same as the flip flop. In this case, the number of necessary cycles is equal to the number of entries to be invalidated. However, as compared with the cache memory unit of the prior art, high-speed processing can be achieved.

Generally, cache replacement requires a long time. Thus even if a plurality of address monitoring setting registers are checked during cache replacement, the performance is not adversely affected. In this case, the address monitoring setting registers are selected as needed in actual invalidation.

As described above, the cache memory unit of the present embodiment can increase the speed of invalidation.

### Second Embodiment

The first embodiment described an example of a configuration for invalidating the lines of the entries by the invalidating circuit.

A second embodiment will describe an example of a configuration for invalidating the lines of entries with software.

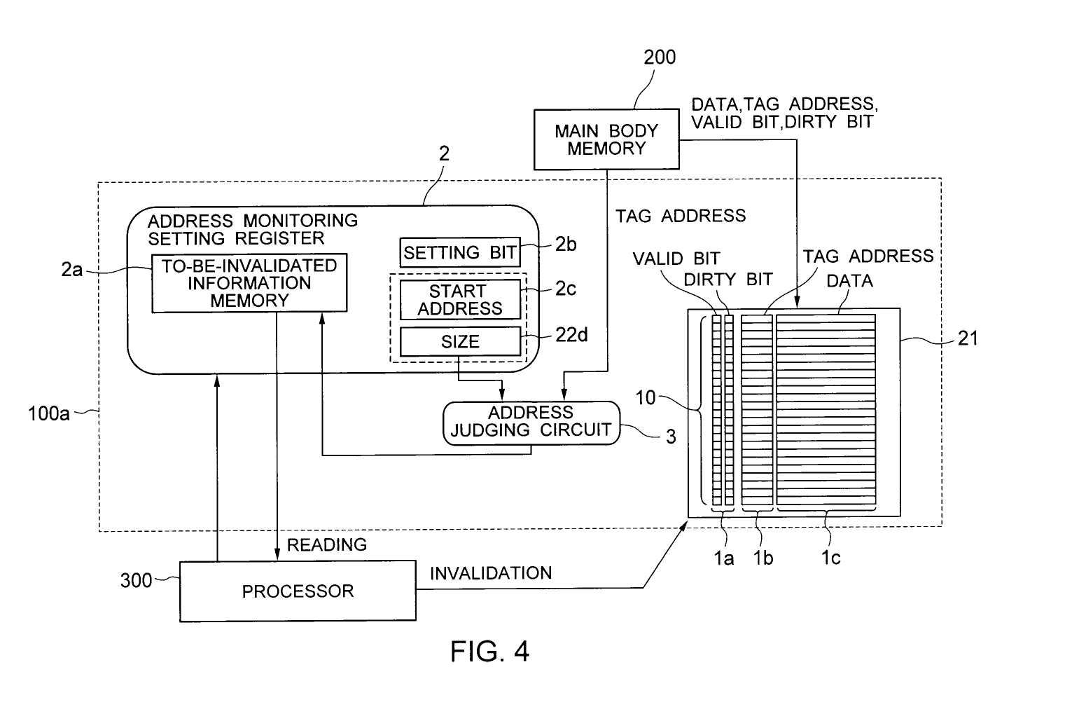

FIG. 4 shows a system configuration including a cache memory unit 100a according to the second embodiment which is an aspect of the present invention.

As shown in FIG. 4, an invalidating circuit 4 is omitted in the cache memory unit 100a unlike the cache memory unit 100 of the first embodiment.

Further, an address monitoring setting register 2 stores a to-be-invalidated address range which includes the addresses of a to-be-invalidated area including data to be invalidated in a main memory 200. The address monitoring setting register 2 stores, for example, a start address 2c and a size 22d of the to-be-invalidated area of the main memory 200, as the to-be-invalidated address range. In other words, addresses to be invalidated are identified by the start address 2c and size of the area.

A processor 300 rewrites the valid bits of a flag memory 1a corresponding to the lines of entries 10 at the to-be-invalidated entry addresses based on the to-be-invalidated entry addresses stored in the address monitoring setting register 2, so as to indicate invalidation of the lines of the entries 10 at the to-be-invalidated entry addresses. Thus the lines of the entries 10 at the to-be-invalidated addresses are invalidated.

Other configurations of the cache memory unit 100a are similar to the configurations of the cache memory unit 100 of the first embodiment. In other words, operations at the setting of the address monitoring setting register 2 and cache replacement are basically similar to the operations of the first embodiment.

In the second embodiment, the operation of the invalidating circuit 4 during invalidation is performed by the processor 300.

To be specific, during invalidation, the processor 300 reads the to-be-invalidated entry addresses stored in the address monitoring setting register 2 and invalidates the corresponding lines of the entries 10 with software stored in the processor 300.

In this case, as compared with the first embodiment, a special invalidating circuit is not necessary and thus a simple configuration can be achieved.

Also in this case, the lines of the entry 10 to be invalidated can be identified by reading a to-be-invalidated information memory 2a with the processor 300. Thus unlike the cache memory unit of the prior art, it is not necessary to sequentially read a tag memory during invalidation. For this reason, the cache memory unit 100a can achieve high-speed processing as compared with the cache memory unit of the prior art.

As described above, the cache memory unit of the present embodiment can increase the speed of invalidation.

As described above, the first and second embodiments described simple direct-mapping schemes as cache memory units.

The present invention is also applicable to a cache memory unit of a set associative scheme such as a two-way or four-way scheme. In this case, bits may be provided in the to-be-invalidated information memory of the address monitoring setting register as many as the number of ways.

In the first and second embodiments, the single address monitoring setting register 2 is provided.

However, more than one address monitoring setting register 2 may be provided. In this case, upon cache replacement, all of the valid addresses monitoring setting registers 2 are operated.

What is claimed is:

1. A cache memory unit that temporarily stores data having been stored in a main memory, comprising:
a cache memory circuit which has entries including a plurality of lines including a data memory for temporarily storing the data having been stored in the main memory, a tag memory for storing tag addresses which are addresses of the data in the main memory, and a flag memory for storing valid bits;
an address monitoring setting register which stores a to-be-invalidated address range including addresses of a to-be-invalidated area of the main memory, and stores entry addresses of the lines of the entries to be invalidated; and
an address judging circuit which compares the tag addresses and the to-be-invalidated address range stored in the address monitoring setting register, and stores, in the address monitoring setting register, to-be-invalidated entry addresses which are the entry addresses of the lines corresponding to the tag memory for storing the tag addresses included in the to-be-invalidated address range, when the tag addresses are included in the to-be-invalidated address range,
wherein the valid bits of the flag memory corresponding to the lines of the entries at the to-be-invalidated entry addresses are rewritten so as to indicate invalidation of the lines of the entries at the to-be-invalidated entry addresses, so that the lines of the entries at the to-be-invalidated entry addresses are invalidated.

2. The cache memory unit according to claim 1, wherein the flag memory is made up of flip-flops.

3. The cache memory unit according to claim 1, further comprising an invalidating circuit fed with a command to invalidate the entries,
wherein when the invalidating circuit is fed with the command, the valid bits of the flag memory corresponding to the lines of the entries at the to-be-invalidated entry addresses are rewritten, based on the to-be-invalidated entry addresses stored in the address monitoring setting register, so as to indicate invalidation of the lines of the entries at the to-be-invalidated entry addresses, so that the lines of the entries at the to-be-invalidated entry addresses are invalidated.

4. The cache memory unit according to claim 2, further comprising an invalidating circuit fed with a command to invalidate the entries,
wherein when the invalidating circuit is fed with the command, the valid bits of the flag memory corresponding to the lines of the entries at the to-be-invalidated entry addresses are rewritten, based on the to-be-invalidated entry addresses stored in the address monitoring setting register, so as to indicate invalidation of the lines of the entries at the to-be-invalidated entry addresses, so that the lines of the entries at the to-be-invalidated entry addresses are invalidated.

5. The cache memory unit according to claim 1, wherein a processor which rewrites the valid bits of the flag memory corresponding to the lines of the entries at the to-be-invalidated entry addresses, based on the to-be-invalidated entry addresses stored in the address monitoring setting register, so as to indicate invalidation of the lines of the entries at the to-be-invalidated entry addresses, so that the lines of the entries at the to-be-invalidated addresses are invalidated.

6. The cache memory unit according to claim 2, wherein a processor which rewrites the valid bits of the flag memory corresponding to the lines of the entries at the to-be-invalidated entry addresses, based on the to-be-invalidated entry addresses stored in the address monitoring setting register, so as to indicate invalidation of the lines of the entries at the to-be-invalidated entry addresses, so that the lines of the entries at the to-be-invalidated addresses are invalidated.

7. The cache memory unit according to claim 1, wherein the to-be-invalidated address range is specified by a start address and an end address of the to-be-invalidated area of the main memory.

8. The cache memory unit according to claim 2, wherein the to-be-invalidated address range is specified by a start address and an end address of the to-be-invalidated area of the main memory.

9. The cache memory unit according to claim 3, wherein the to-be-invalidated address range is specified by a start address and an end address of the to-be-invalidated area of the main memory.

10. The cache memory unit according to claim 4, wherein the to-be-invalidated address range is specified by a start address and an end address of the to-be-invalidated area of the main memory.

11. The cache memory unit according to claim 5, wherein the to-be-invalidated address range is specified by a start address and an end address of the to-be-invalidated area of the main memory.

12. The cache memory unit according to claim 6, wherein the to-be-invalidated address range is specified by a start address and an end address of the to-be-invalidated area of the main memory.

13. A cache memory unit that temporarily stores data having been stored in a main memory, comprising:
a cache memory circuit which has entries including a plurality of lines including a data memory for temporarily storing the data having been stored in the main memory, a tag memory for storing tag addresses which are addresses of the data in the main memory, and a flag memory for storing valid bits;
an address monitoring setting register which stores a to-be-invalidated address range including addresses of a to-be-invalidated area of the main memory, and stores entry addresses of the lines of the entries to be invalidated; and
an address judging circuit which compares the tag addresses and the to-be-invalidated address range stored in the address monitoring setting register, and stores, in the address monitoring setting register, to-be-invalidated entry addresses which are the entry addresses of the lines corresponding to the tag memory for storing the tag addresses included in the to-be-invalidated address range, when the tag addresses are included in the to-be-invalidated address range,
wherein the valid bits of the flag memory corresponding to the lines of the entries at the to-be-invalidated entry addresses are rewritten so as to indicate invalidation of the lines of the entries at the to-be-invalidated entry addresses, so that the lines of the entries at the to-be-invalidated entry addresses are invalidated,
the to-be-invalidated address range is specified by a start address and the size of the to-be-invalidated area of the main memory.

14. The cache memory unit according to claim 13, wherein the flag memory is made up of flip-flops.

15. The cache memory unit according to claim 13, further comprising an invalidating circuit fed with a command to invalidate the entries,
wherein when the invalidating circuit is fed with the command, the valid bits of the flag memory corresponding to the lines of the entries at the to-be-invalidated entry addresses are rewritten, based on the to-be-invalidated entry addresses stored in the address monitoring setting register, so as to indicate invalidation of the lines of the entries at the to-be-invalidated entry addresses, so that the lines of the entries at the to-be-invalidated entry addresses are invalidated.

16. The cache memory unit according to claim 14, further comprising an invalidating circuit fed with a command to invalidate the entries,
wherein when the invalidating circuit is fed with the command, the valid bits of the flag memory corresponding to the lines of the entries at the to-be-invalidated entry addresses are rewritten, based on the to-be-invalidated entry addresses stored in the address monitoring setting register, so as to indicate invalidation of the lines of the entries at the to-be-invalidated entry addresses, so that the lines of the entries at the to-be-invalidated entry addresses are invalidated.

17. The cache memory unit according to claim 13, wherein a processor which rewrites the valid bits of the flag memory corresponding to the lines of the entries at the to-be-invalidated entry addresses, based on the to-be-invalidated entry addresses stored in the address monitoring setting register, so as to indicate invalidation of the lines of the entries at the to-be-invalidated entry addresses, so that the lines of the entries at the to-be-invalidated addresses are invalidated.

18. The cache memory unit according to claim 14, wherein a processor which rewrites the valid bits of the flag memory corresponding to the lines of the entries at the to-be-invalidated entry addresses, based on the to-be-invalidated entry addresses stored in the address monitoring setting register, so as to indicate invalidation of the lines of the entries at the to-be-invalidated entry addresses, so that the lines of the entries at the to-be-invalidated addresses are invalidated.

19. A cache memory unit that temporarily stores data having been stored in a main memory, comprising:
a cache memory circuit which has entries including a plurality of lines including a data memory for temporarily storing the data having been stored in the main memory, a tag memory for storing tag addresses which are addresses of the data in the main memory, and a flag memory for storing valid bits;
an address monitoring setting register which stores a to-be-invalidated address range including addresses of a to-be-invalidated area of the main memory, and stores entry addresses of the lines of the entries to be invalidated; and
an address judging circuit which compares the tag addresses and the to-be-invalidated address range stored in the address monitoring setting register, and stores, in the address monitoring setting register, to-be-invalidated entry addresses which are the entry addresses of the lines corresponding to the tag memory for storing the tag addresses included in the to-be-invalidated address range, when the tag addresses are included in the to-be-invalidated address range.

20. The cache memory unit according to claim 19, wherein the flag memory is made up of flip-flops.
